(19) United States
(12) Patent Application Publication
(10) Pub. No.: US 2019/0370408 A1
(43) Pub. Date: Dec. 5, 2019

(54) DATAFLOW EXECUTION GRAPH MODIFICATION USING INTERMEDIATE GRAPH

(71) Applicant: Microsoft Technology Licensing, LLC, Redmond, WA (US)

(72) Inventors: Rahul POTHARAJU, Redmond, WA (US); Kai ZENG, Redmond, WA (US); Paolo COSTA, London (GB); Terry Yumin KIM, Bellevue, WA (US); Sudheer DHULIPALLA, Sammamish, WA (US); Saravanan MUTHUKRISHNAN, Sammamish, WA (US); Shivaram VENKATARAMAN, Seattle, WA (US); Le XU, Urbana, IL (US); Lao MAI, London (GB); Steve D. SUH, Redmond, WA (US); Sriram RAO, Saratoga, CA (US)

(21) Appl. No.: 15/994,918

(22) Filed: May 31, 2018

(51) Int. Cl. G06F 17/30; G06F 8/41

(52) U.S. Cl. CPC G06F 17/30958; G06F 8/433; G06F 17/30516

(57) ABSTRACT

Mechanisms to modify a dataflow execution graph that processes a data stream. An intermediate dataflow execution graph is used during modification of the dataflow execution graph from one configuration (the old dataflow execution graph) to the next (the new dataflow execution graph). Data messages of the data stream may continue to feed into the intermediate dataflow execution graph, thereby reducing latency and maintaining throughput during reconfiguration of the dataflow execution graph. Control message(s) that are structured to accomplish the reconfiguration is/are also passed into the intermediate dataflow execution graph during reconfiguration. As the control message(s) are all processed by the intermediate dataflow execution graph, the intermediate dataflow execution graph assumes the topology of the new dataflow execution graph.

### BACKGROUND

Large scale cloud and Internet service providers typically generate millions of events per second. To handle such high event throughput, events are often accumulated, prior to being processed as a batch. More recently, to reduce latency and to ensure timely event processing, stream processing systems avoid batching by processing the events as a stream.

There can be high variability (called herein “temporal variability”) in the volume of events that are being streamed with each event stream. For instance, an event stream can include a mix of expected events (e.g., processing needs during the day can be typically higher than at night, and so forth), and unexpected events (e.g., dramatic stock market changes, and so forth). Furthermore, each event stream has different resource requirements due to there being different workload characteristics (called herein “spatial variability”) across event streams. Furthermore, in large-scale systems, there are inevitable failures and hardware heterogeneity that make it hard to ensure stable performance in processing event streams. To handle these variabilities and uncertainties, users of stream processing systems (typically system administrators) often provision resources with a safety factor, leaving many resources idle or underutilized.

Many existing stream processing systems adopt a streaming dataflow computational model. In this model, a computational job is represented as a directed acyclic graph (DAG) of operators, which is also called a “dataflow execution graph”. Although such operators may be stateless, such operators are most often stateful in that they maintain mutable local state. Each operator sends and/or receives logically timestamped events along directed edges of the DAG. Upon receiving an event along an input edge(s), an operator updates its local state if appropriate, potentially generates new events, and sends those new events to downstream operators along output edge(s). Operators without input edges are termed “source” operators, or simply “sources”. Operators without output edges are termed “sink” operators, or simply “sinks”. An edge in a DAG has no state but can have configurable properties. For example, a property of an edge might be queue size thresholds that trigger back-pressure.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to mechanisms to modify a dataflow execution graph that processes one or more data streams. Typically, when modifying a dataflow execution graph, the old dataflow execution graph is stopped, and the state of the dataflow execution graph is checkpointed. The state from the old dataflow execution graph is then migrated to the new dataflow execution graph. The data stream(s) is/are then resumed on the new dataflow execution graph. This pausing and resuming of the data stream(s) will likely trigger significant back-pressure, causing latency and loss of throughput, and in turn limiting the frequency and granularity of dataflow execution graph reconfigurations.

In accordance with the principles described herein, an intermediate dataflow execution graph is used during modification of the dataflow execution graph from one configuration (i.e., the “old dataflow execution graph”) to the next (i.e., the “new dataflow execution graph”). Data messages of the data stream(s) may continue to feed into the intermediate dataflow execution graph, thereby reducing latency and maintaining throughput during reconfiguration of the dataflow execution graph. Control messages that are structured to accomplish the reconfiguration are also passed into the intermediate dataflow execution graph.

The intermediate dataflow execution graph includes operators and edges that represent the functional union of the old and new dataflow execution graphs. More precisely, the intermediate dataflow execution graph has operators that include at least common operators of both the old and new dataflow execution graphs, and the intermediate dataflow execution graph has edges that include at least common edges of both the old and new dataflow execution graphs. The edges may also include those edges for which there is a state dependency between an operator of the old dataflow execution graph and an operator of the new dataflow execution graph.

From this state, the intermediate dataflow execution graph gracefully morphs into the new dataflow execution graph. For each operator of the intermediate dataflow execution graph that is not part of the new dataflow execution graph, that operator is shut down after executing the control message(s), such that the operator ceases to be able to continue processing data messages. For each operator of the intermediate dataflow execution graph that is not part of the old dataflow execution graph, that operator begins processing of data messages after the operator processes the control message(s).

Thus, during the reconfiguration of the dataflow execution graph, the overall function of the dataflow execution graph does not change, and the dataflow execution graph continues to operate upon the data stream(s). Latency associated with reconfiguration is thus reduced. Throughput during reconfiguration is maintained, or at least reductions in throughput are mitigated. With such drawbacks of reconfiguration being alleviated, the dataflow execution graph may be more freely configured to respond to variability and uncertainty in and across data streams. Thus, overprovisioning of resources to support the dataflow execution graph can be avoided.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an environment in which the principles described herein may be employed, which includes a configuration application, a controller, and a dataflow execution graph that performs a computational job on data streams;

FIG. 2A illustrates a relatively simple example of a dataflow execution graph, which may be an example of the dataflow execution graph of FIG. 1;

FIG. 2B illustrates a more complex example of a dataflow execution graph, which may also be an example of the dataflow execution graph of FIG. 1;

FIG. 3A illustrates an example stateful operator, which includes state, a function, and potentially parameter(s);

FIG. 3B illustrates an example stateless operator, which includes a function, and potentially parameter(s);

FIG. 4 illustrates an example edge, which includes no state or function, but does potentially include parameter(s);

FIG. 5 illustrates a flowchart of a method for modifying a dataflow execution graph that processes a data stream(s) in accordance with the principles described herein;

FIG. 6 illustrates an example new dataflow execution graph, which represents a modified version of the old dataflow execution graph of FIG. 2A;

FIG. 7A illustrates a first example intermediate dataflow execution graph used in the example in which the old dataflow execution graph is that of FIG. 2A, and the new dataflow execution graph is that of FIG. 6;

FIG. 7B illustrates a second example intermediate dataflow execution graph, which is the same as that of FIG. 7A, except with an optimization performed to take advantage of the fact that some of the operators do not change their state;

FIG. 7C illustrates a third example intermediate dataflow execution graph, which is the same as that of FIG. 7B, except with another optimization performed to take advantage of the fact that the dataflow execution graph is acyclic;

FIG. 8 is a diagram showing a timeline view of the described reconfiguration; and

FIG. 9 illustrates an example computer system in which the principles described herein may be employed.

### DETAILED DESCRIPTION

At least some embodiments described herein relate to mechanisms to modify or reconfigure a dataflow execution graph that processes one or more data streams. In accordance with the principles described herein, an intermediate dataflow execution graph is used during modification of the dataflow execution graph from one configuration (i.e., the “old dataflow execution graph”) to the next (i.e., the “new dataflow execution graph”). During reconfiguration, data messages of the data stream(s) may continue to feed into the intermediate dataflow execution graph, thereby reducing latency and maintaining throughput during reconfiguration of the dataflow execution graph. Control messages that are structured to accomplish the reconfiguration are also passed into the intermediate dataflow execution graph. As the control message(s) are processed by various operators within the dataflow execution graph, the intermediate dataflow execution gracefully takes the shape of the new dataflow execution graph.

Thus, during the reconfiguration of the dataflow execution graph, the overall function of the dataflow execution graph does not change, and the dataflow execution graph continues to operate upon the data stream(s). Latency associated with reconfiguration is thus reduced. Throughput during reconfiguration is maintained, or at least reductions in throughput are mitigated. With such drawbacks of reconfiguration being alleviated, the dataflow execution graph may be more freely configured and reconfigured to respond to variability and uncertainty in and across the data streams. Thus, overprovisioning of resources to support the dataflow execution graph can be avoided.

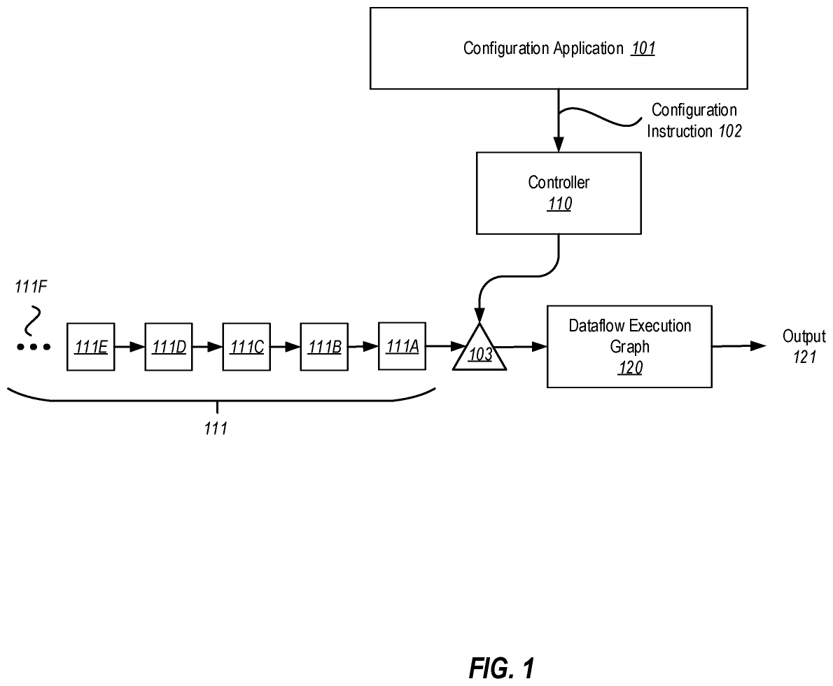

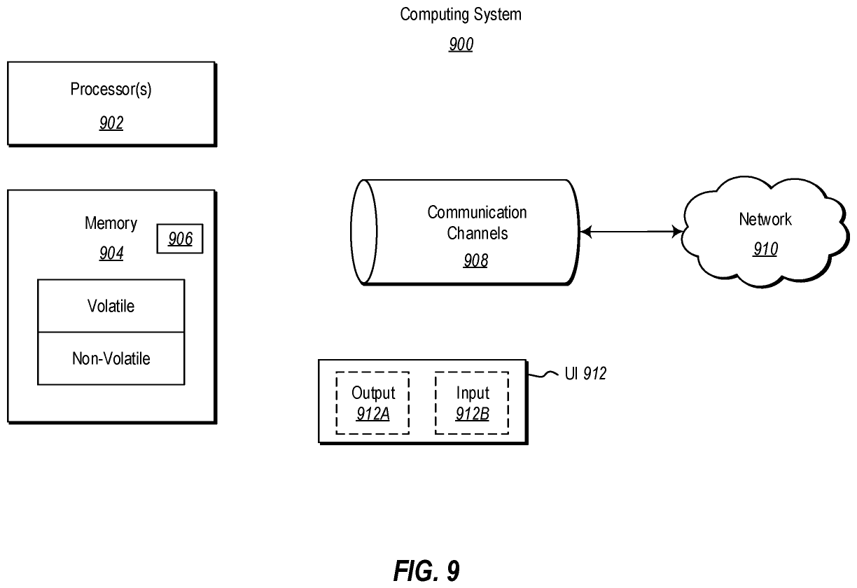

FIG. 1 illustrates an environment 100 in which the principles described herein may be employed. The environment 100 includes a configuration application 101, a controller 110, and a dataflow execution graph 120. The configuration application 101 may be software running on a computing system, such as the computing system 900 described below with respect to FIG. 9. The controller 110 may be an executable component, such as the executable component 906 described below with respect to FIG. 9. That said, the configuration application 101 and the controller 110 need not run on the same computing system and may even each be distributed across multiple computing systems.

One or more data streams 111 feeds into the dataflow execution graph 120 and generates the output result 121. Thus, the dataflow execution graph 120 represents a computational job performed on the data stream(s) 111. As an example, the computational job may be a streaming or standing query. The data stream(s) 111 may each be streams of any type of data messages. In one embodiment, each of one or more or all of the data stream 111 is an event stream in which the data messages are events. The dataflow execution graph 120 may be local to, or remote from, the controller 110. The dataflow execution graph 120 may thus be on the same computing system as, or on a different computing system than, the controller 110. The dataflow execution graph 120 may be on a single computing system or may be distributed across multiple computing systems. The environment 900 may, but need not, be a cloud computing environment such as that described below after FIG. 9.

In the streaming dataflow computational model, a computational job is represented as a directed acyclic graph (DAG) of operators, which is also called a dataflow execution graph. Although such operators may be stateless, such operators are often stateful in that they maintain mutable local state. Each operator sends and/or receives logically timestamped data messages along directed edges of the dataflow execution graph. Upon receiving a data message along an input edge, an operator updates its local state if appropriate, potentially generates new data messages, and sends those new data messages to downstream operators along output edge(s). Operators without input edges are termed “source” operators, or simply “sources”. These source operators receive the raw input data messages of the data stream(s) 111. For instance, one or more of the source operators may receive data messages from one data stream, and one or more other of the source operators may receive data messages from another data stream, and so forth. Operators without output edges are termed “sink” operators, or simply “sinks”. One or more of these sink operators generate the output result 121 of the dataflow execution graph 120. An edge in a dataflow execution graph often has no state, but can have properties. For example, a property of an edge might be a queue backlog size threshold that triggers back-pressure. Edges can also have state that is useful. For instance, during checkpointing, an edge's state might also be checkpointed to avoid replaying data in-flight.

The controller 110 issues a control message 103 to the dataflow execution graph 120, which is fed into the dataflow execution graph 120 in the same way as the data messages of the data stream(s) 111. Specifically, the control message 103 may be input to each source operator of the dataflow execution graph 120. In the illustrated embodiment of FIG. 1, the input data messages of the data stream 111 are represented as squares, and the control message 103 from the controller 110 is represented as a triangle. The control message 103 is different than the data messages of the data stream 111 in that the control message 103 is structured to be executable by the dataflow execution graph 120 to actually change the configuration of the dataflow execution graph 120. The data messages do not change the configuration of the dataflow execution graph 120, but are simply processed by the dataflow execution graph 120. As an example, a control message can also contain a small “executable” program that can be executed by the operator. An example for this could be an anonymous/lambda function that needs to be executed as part of a new streaming DAG.

In the illustrated embodiment, there are five data messages 111A through 111E illustrated as being part of the data stream(s) 111. The ellipsis 111F represents that there may be any number of data messages within a data stream. The control message 103 is shown in line with the data messages 111A through 111E to represent that the control message 103 is received into the dataflow execution graph 120 by all source operators with the dataflow execution graph 120. Although only one control message 103 is shown as issued by the controller 110 in FIG. 1, multiple control messages may be fed into the dataflow execution graph 120 in order to accomplish a particular reconfiguration of the dataflow execution graph 120. Furthermore, control messages may be used to reconfigure the dataflow execution graph 120 multiple times as desired to respond to the variability and uncertainty in and across the data stream(s) 111. Thus, the dataflow execution graph 120 can respond dynamically and frequently to changing conditions.

In one embodiment, the controller 110 autonomously determines that the dataflow execution graph 120 is to be reconfigured, and generates appropriate control message(s) to accomplish the reconfiguration. Alternatively or in addition, the controller 110 makes the determination wholly or in part due to a configuration instruction 102 received from the configuration application 101. The configuration application 101 may be a software application or service accessible to a user of the data stream 111 (such as perhaps a system administrator). The configuration instruction 102 may be very precise, perhaps even specifying what the control message(s) are to be, in which case the controller 110 simply passes those control messages into the dataflow execution graph. On the other extreme, the configuration instruction 102 may simply be a high-level directive, in which case the controller 110 exercises appropriate logic and accesses appropriate environmental information to thereby determine the timing and nature of appropriate reconfigurations, and consequently generate appropriate control message(s).

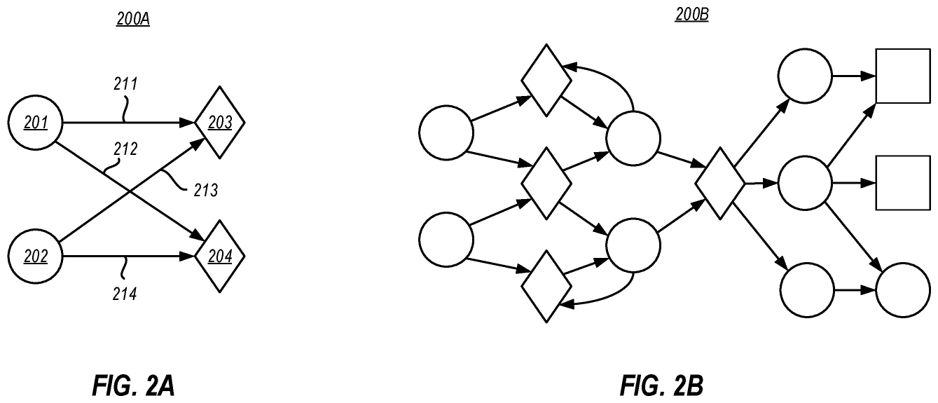

The dataflow execution graph 120 may include any number of operators and any number of edges in any configuration. The dataflow execution graph 120 may be as simple as a single operator, with zero edges. On the other hand, the dataflow execution graph may be indescribably complex, having innumerable operators and edges therebetween. FIGS. 2A and 2B illustrate a mere two examples of the infinite variety of dataflow execution graphs upon which the principles described herein may operate.

FIG. 2A illustrates a still relatively simple example in the form of a dataflow execution graph 200A, which again may be an example of the dataflow execution graph 120 of FIG. 1. The dataflow execution graph 200A includes only four operators 201, 202, 203 and 204, and only four directed edges 211, 212, 213 and 214. In this example, the operators 201 and 202 are stateless as symbolized by the operators each being illustrated as a circle, and the operators 203 and 204 are stateful as symbolized by the operators each being illustrated as a rhombus. The directed edges generally are directed rightward. The operators 201 and 202 are source operators, each receiving the input data messages of the data streams. As an example, perhaps source operator 201 receives input data messages from one data stream, and source operator 202 receives input data messages from another data stream. The operators 203 and 204 are sink operators, each providing output from the dataflow execution graph 200A.

FIG. 2A will be used as the original or “old” dataflow execution graph in an example configuration that will be described hereinafter. Thus, the dataflow execution graph 200A will also be referred to herein as the “example old dataflow execution graph” herein. However, to illustrate that the dataflow execution graph 120 may be more complex, FIG. 2B illustrates a dataflow execution graph 200B with numerous stateless and stateful operators, and numerous edges. The dataflow execution graph 200B is not even acyclic, which demonstrates that the principles described herein are not restricted to the dataflow execution graph being acyclic. However, if the streaming dataflow computational model is conformed with, the dataflow execution graph will be a directed acyclic graph.

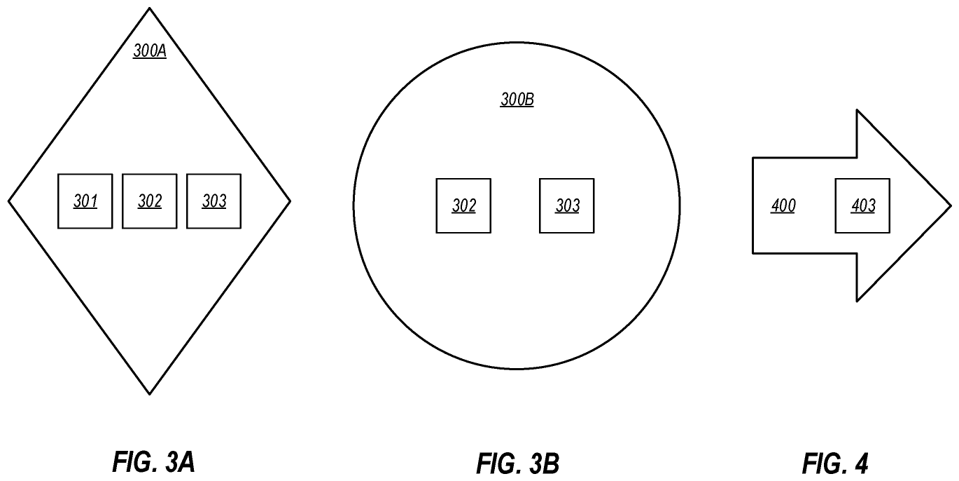

For completeness, FIG. 3A illustrates an example stateful operator 300A, which includes state 301, one or more functions 302, and potentially parameter(s) 303. FIG. 3B illustrates an example stateless operator 300B, which includes no state 301, but does include function(s) 302 and potentially parameter(s) 303. FIG. 4 illustrates an example edge 400, which includes no state 301 or function 302, but does potentially include parameter(s) 303.

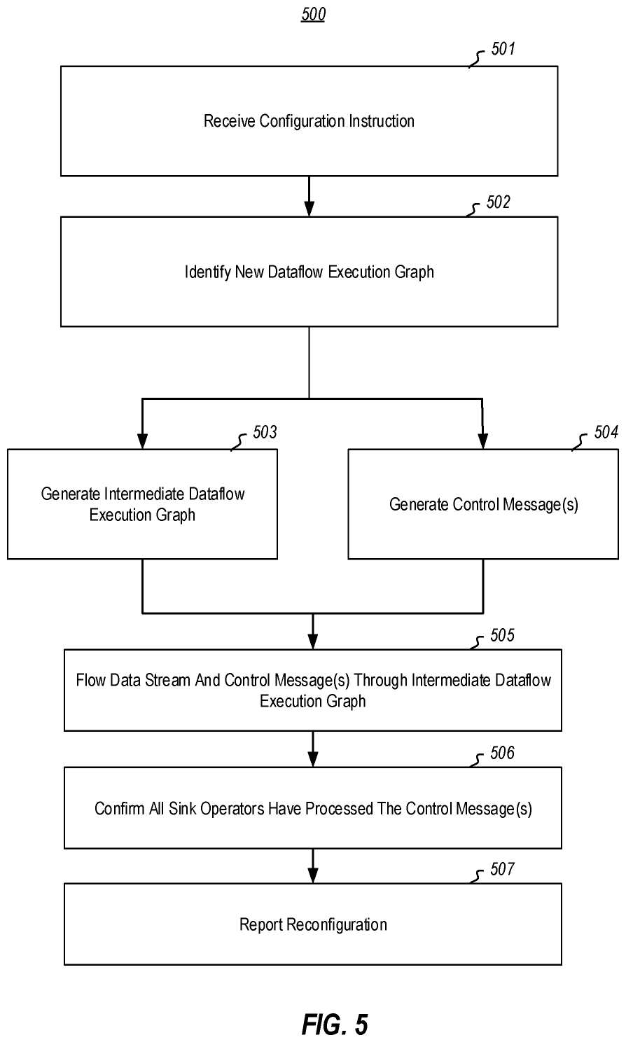

FIG. 5 illustrates a flowchart of a method 500 for modifying a dataflow execution graph that processes a data stream. As the method 500 may be performed by the controller 110 in the environment 100 of FIG. 1, the method 500 of FIG. 5 will be described with respect to the environment 100 of FIG. 100. Also, as the example old dataflow execution graph 200A of FIG. 2A is going to be used as an example dataflow execution graph that is modified, reference to FIG. 2A will also be frequent.

The method 500 of FIG. 5 includes receiving a configuration instruction (act 501). For instance, in FIG. 1, the controller 110 receives the configuration instruction 102 as previously described. Also, as previously mentioned, in some embodiments, the controller 110 generates control message(s) without needing a configuration instruction 102. However, the use of the configuration application 101 allows a user of the data stream 111 (such as a system administrator) to provide input into when and how the dataflow execution graph 120 may be modified.

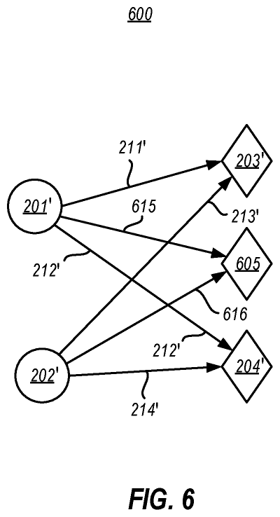

The method 500 also determines a new dataflow execution graph that the old dataflow execution graph is to be changed to (act 502). As an example, suppose that the example old dataflow execution graph 200A of FIG. 2A is to be modified to a new dataflow execution graph 600 of FIG. 6. Note the addition of stateful operator 605, and edges 615 and 616 to the old dataflow execution graph 200A would form the new dataflow execution graph 600. This modification might be performed if, for instance, the operators 201 and 202 were mapping operators, and operators 203 and 204 were reducer operators in a map-reduce model, and in which case it was decided to scale-out (i.e., increase) the number of reducer operators by one.

The operators 201′, 202′, 203′ and 204′ of the example new dataflow execution graph 600 of FIG. 6 are the same operators 201, 202, 203 and 204, respectively, of the example old dataflow execution graph 200A of FIG. 2A. Thus, the operators 201 and 201′ are “common”, operators 202 and 202′ are common, operators 203 and 203′ are common, and operators 204 and 204′ are common. However, the prime suffix is added in FIG. 6 to represent that the operator may have its function (e.g., function 302), parameter(s) (e.g., parameters 303) and/or state (e.g., state 301 in the case of a stateful operator) changed as a result of the reconfiguration, and still be considered a common operator between the old and new dataflow execution graphs. Likewise, the edges 211′, 212′, 213′ and 214′ of the example new dataflow execution graph 600 of FIG. 6 are the same edges as (or common with) edges 211, 212, 213 and 214, respectively, of the example old dataflow execution graph 200A of FIG. 2A. Again, the prime suffix is added to represent that the edge may have its parameter(s) (e.g., parameters 403) changed during the reconfiguration, and still be considered a common edge between the old and new dataflow execution graphs.

In the environment 100 of FIG. 1, the controller 110 may make this determination of the new dataflow execution graph autonomously, or based on a configuration instruction 102. If there has been a configuration instruction 102, the identification of the new dataflow execution graph may have been in response to, or based at least in part on, the configuration instruction 102. As an example, the configuration instruction 102 might be simply to scale out one type of operator when utilization of the operators of that type reaches a predetermined threshold. The controller 110 may evaluate the capacity of the operators, and when that predetermined threshold is reached, identify a new dataflow execution graph topology that would reduce utilization of the operators of that type to below the predetermined level.

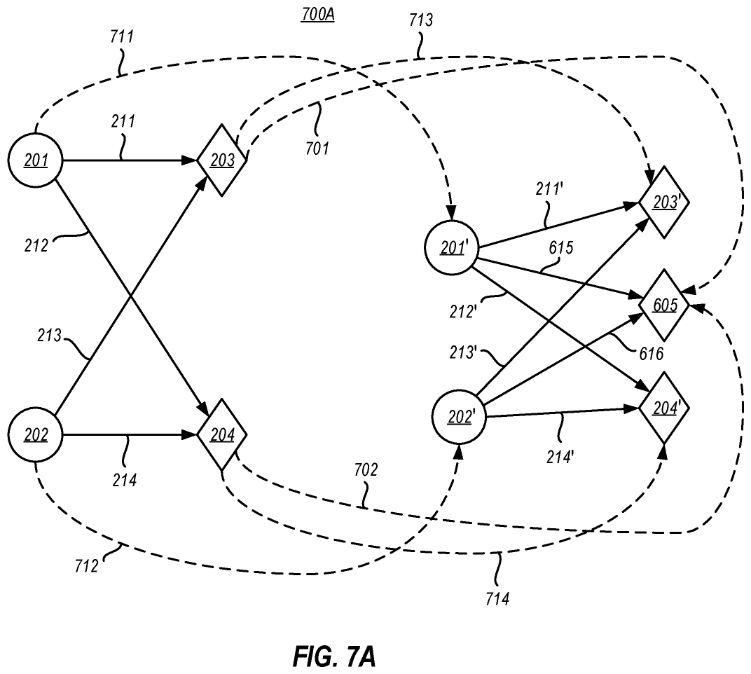

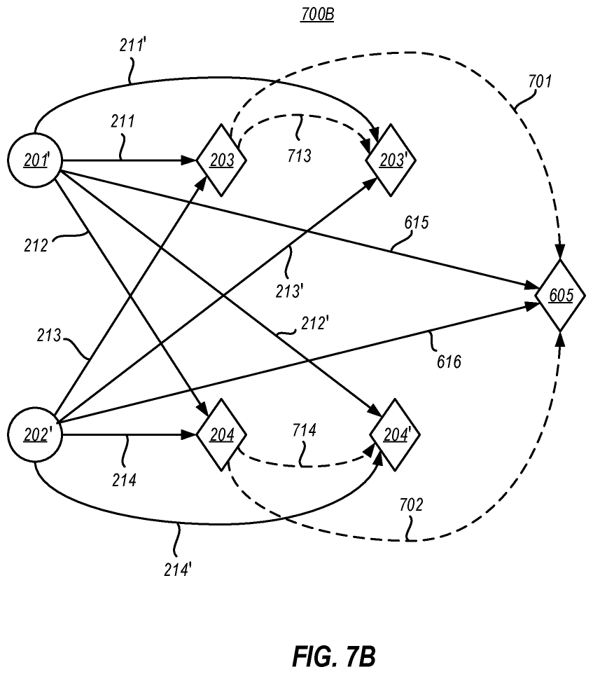

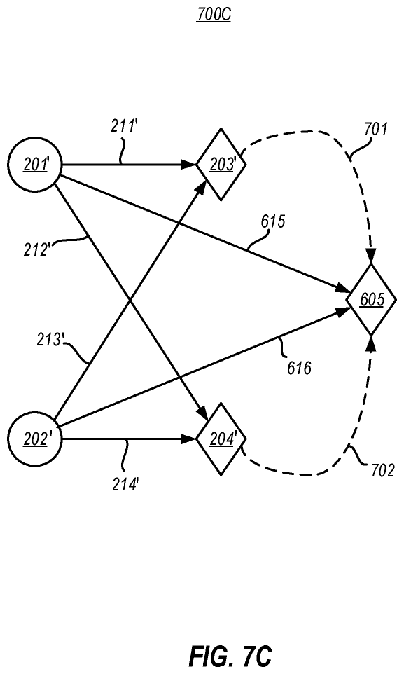

The method 500 also includes generating an intermediate dataflow execution graph (act 503) based on both the old dataflow execution graph that is about to be modified, as well as the new dataflow execution graph that is to be the result of the modification. More regarding the intermediate dataflow execution graph will be described with respect to the example old dataflow execution graph 200A, the example new dataflow execution graph 600, and the associated example intermediate dataflow execution graphs 700A, 700B, and 700C of FIGS. 7A through 7C, respectively.

Suffice it for now to say that the intermediate dataflow execution graph includes at least the common operators of both the old and new dataflow execution graphs, and includes the common edges of both the old and new dataflow execution graphs. For instance, for the example old dataflow execution graph 200A, and the example new dataflow execution graph 600, there are common operators 201 through 204 that are within both the example old dataflow execution graph 200A and the example new dataflow execution graph 600. Furthermore, there are common edges 211 through 214 that are within both the example old dataflow execution graph 200A and the example new dataflow execution graph 600.

The method 500 also includes generating one or more control message(s) that are not part of the data stream (act 504). These control message(s) are structured such that, when executed by the operators within the intermediate dataflow execution graph, the intermediate dataflow execution graph will take the form of the new dataflow execution graph. As an example, in the environment 100 of FIG. 1, the controller 110 generates the control message 103. That control message is not part of the data stream 111 because that control message 103 is not a data message of that data stream 111. The control message 103 represents the topology of the new dataflow execution graph, and possibly also new or modified functions that are to be performed by specified operators, new or modified parameters or parameter values that are to be held by operators or edges, and how state is to be allocated amongst multiple stateful operators.

The data stream(s) is/are then flowed to the intermediate dataflow execution graph (act 505) along with the control message(s) (also act 505). Note that this flowing of the data stream(s) is not deferred until the new dataflow execution graph. As an example, in the environment 100 of FIG. 1, the data stream(s) 111 and the control message 103 are fed into the dataflow execution graph 120, which is now the intermediate dataflow execution graph during the reconfiguration. Because of the way the control message(s) is/are structured, the intermediate dataflow execution graph will take the form of the new dataflow execution graph as each operator completes execution of the control message(s).

Specifically, for each operator of the intermediate dataflow execution graph that is not part of the new dataflow execution graph, the operator is shut down after that operator executes at least one (and preferably all) of the control message(s), such that the operator ceases to be able to continue processing data messages of the data stream after shut down. As such an operator receives a control message on one of its input edges, the operator closes that input channel so that it does not receive data messages on that input edge. After all control messages are received on all of the input edges for that operator, the operator will no longer receive data messages. For each operator of the intermediate dataflow execution graph that is not part of the old dataflow execution graph, that operator begins processing of data messages of the data stream after the operator processes at least one (and preferably all) of the control message(s).

When the sink operators within the intermediate dataflow execution graph complete execution of the control messages, the operators each report the completion to the controller 110. When the controller 110 confirms that all sink operators in the dataflow execution graph have executed the control messages (act 506), the controller 110 can understand that the intermediate dataflow execution graph has now taken the form of the new dataflow execution graph, and that the data stream(s) is/are being fed into and processed by that new dataflow execution graph. If appropriate, this reconfiguration may be reported to the configuration application 101 (act 507).

FIG. 7A includes one example intermediate dataflow execution graph 700A that is based on the example old dataflow execution graph 200A and the example new dataflow execution graph 600. Specifically, the intermediate dataflow execution graph 700A includes all operators of both the old dataflow execution graph 200A and the new dataflow execution graph 600. That is, the intermediate dataflow execution graph 700A includes operators 201 through 204, 201′ through 204′ and 605, for both stateless operators and stateful operators. The intermediate dataflow execution graph 700A also includes edges of both the old dataflow execution graph 200A and the new dataflow execution graph. That is, the intermediate dataflow execution graph 700A includes edges 211 through 214, 211′ through 214′, 615 and 616. Such edges are represented by solid-lined arrows.

The intermediate dataflow execution graph 700A also includes additional edges represented by dotted-line arrows. Such edges include edges that capture state dependency relationships between stateful operator(s) of the old dataflow execution graph and stateful operator(s) of the new dataflow execution graph. For instance, suppose that as part of the reconfiguration, some state is to be transferred from operator 203 to new operator 605. As such, there is a new edge 701 representing this dependency. Furthermore, suppose that as part of the reconfiguration, some state is to be transferred from operator 204 to new operator 605. As such, there is a new edge 702 representing this state dependency.

The intermediate dataflow execution graph 700A also includes new edges between each common operator of the old dataflow execution graph 200A and the new dataflow execution graph 600. For instance, there is a new edge 711 from operator 201 to operator 201′, a new edge 712 from operator 202 to operator 202′, a new edge 713 from operator 203 to operator 203′, and a new edge 714 from operator 204 to operator 204′. Thus, the intermediate dataflow execution graph 700A includes nine operators 201 through 204, 201′ through 204′ and 605; and sixteen edges 211 through 214, 211′ through 214′, 615, 616, 701, 702, and 711 through 714.

Eventually, the intermediate dataflow execution graph 700A will collapse into the new dataflow execution graph 600 once all operators have completed processing the control message. Recall that for each operator of the intermediate dataflow execution graph 700A that is not part of the new dataflow execution graph 600 (which includes all of the original operators 201, 202, 203 and 204), that operator will shut down after executing the control message received on all of its input edges. Also, for each operator of the intermediate dataflow execution graph 700A that is not part of the old dataflow execution graph 200A (which includes all of the operators 201′, 202′, 203′ and 204′), that operator will begin processing data messages after executing the control message received on each of its input edges.

The control message is provided first to the operators 201 and 202, which respond by each stopping data messages on the input channels. After operator 201 processes the control message, the control message is passed along directed edges 211, 212 and 711 to respective operators 203, 204 and 201′, and the operator 201 will thereafter shut down, thereby also extinguishing the directed edges 211, 212 and 711. After operator 202 processes the control message, the control message is passed along directed edges 213, 214 and 712 to respective operators 203, 204 and 202′, and the operator 202 will thereafter shut down, thereby also extinguishing the directed edges 213, 214 and 712.

After operator 201′ processes the control message, the control message is passed along directed edges 211′, 615 and 212′ to respective operators 203′, 605 and 204′, and the operator 201′ thereafter begins processing incoming data messages. Likewise, after operator 202′ processes the control message, the control message is passed along directed edges 213′, 616 and 214′ to respective operators 203′, 605 and 204′, and the operator 202′ thereafter begins processing incoming data messages. At this point, the intermediate dataflow execution graph once again accepts input data messages, which is only a brief moment after the intermediate dataflow execution graph stopped accepting input data messages (when the operators 201 and 202 received the control message).

As part of processing the control message, operator 203 will perform some transform on its own state as dictated by the control message, and provide that transformed state along directed edge 701 to the operator 605. After operator 203 processes the control message, the control message is passed along directed edges 713 and 701 to respective operators 203′ and 605, and the operator 203 will thereafter shut down, thereby also extinguishing the directed edges 713 and 701. As part of processing the control message, operator 204 will perform some transform on its own state as directed by the control message, and provide that transformed state along directed edge 702 to the operator 605. After operator 204 processes the control message, the control message is passed along directed edges 702 and 714 to respective operators 605 and 204′, and the operator 203 will thereafter shut down, thereby also extinguishing the directed edges 702 and 714.

After operators 203′, 605 and 204′ each process the control message, the respective operator thereafter begins processing incoming data messages, and also reports the completion of the processing of the control message to the controller. At this point, the intermediate dataflow execution graph 700A has taken the form of the new dataflow execution graph 600, and the data stream is executing on the new dataflow execution graph 600.

While some amount of back-pressure may be caused in this situation, the amount of back-pressure is much less than the freeze-the-world approach where the old dataflow execution graph is stopped, the state of the old dataflow execution graph is checkpointed, the new dataflow execution graph is generated, the checkpointed state is transferred to appropriate operators in the new dataflow execution graph, and only then the new dataflow execution graph is started. Thus, the principles described herein significantly reduces latency and increases throughput during reconfiguration of a dataflow execution graph.

One optimization is based on recognizing that when the control message does not change the operator's state (e.g., as in the case for operators 201, 201′, 202 and 202′ since they are stateless), the respective common operators can be collapsed into one operator, eliminating the corresponding link therebetween. FIG. 7B illustrated an example intermediate dataflow execution graph 700B that is similar to the dataflow execution graph 700A of FIG. 7A, except with the described optimization. Specifically, operators 201 and 201′ are collapsed into operator 201′, and corresponding edge 711 is absent. Also, operators 202 and 202′ are collapsed into operator 202′, and the corresponding edge 712 is absent. Thus, there are only now seven operators 201′, 202′, 203, 204, 203′, 204′ and 605 in the intermediate dataflow execution graph 700B. There are fourteen edges 211 through 214, 211′ through 214′, 615, 616, 701, 702, 713 and 714, in the intermediate dataflow execution graph 700B.

In FIG. 7B, the control message is provided first to the operators 201′ and 202′. After operator 201′ processes the control message, the control message is passed along directed edges 211′, 211, 615, 212 and 212′ to respective operators 203′, 203, 605, 204 and 204′. The operator 201′ will then begin processing data messages since it an operator within the new dataflow execution graph 600. After operator 202′ processes the control message, the control message is passed along directed edges 213, 213′, 616, 214 and 214′ to respective operators 203, 203′, 605, 204 and 204′. The operator 202′ will then begin processing data messages since it an operator within the new dataflow execution graph 600.

As part of processing the control message, operator 203 will perform some transform on its own state as dictated by the control message, and provide that transformed state along directed edge 701 to the operator 605. After operator 203 processes the control message, the control message is passed along directed edges 713 and 701 to respective operators 203′ and 605, and the operator 203 will thereafter shut down, thereby also extinguishing the directed edges 211, 213, 713 and 701. As part of processing the control message, operator 204 will perform some transform on its own state as directed by the control message, and provide that transformed state along directed edge 702 to the operator 605. After operator 204 processes the control message, the control message is passed along directed edges 702 and 714 to respective operators 605 and 204′, and the operator 203 will thereafter shut down, thereby extinguishing the directed edges 212, 214, 702 and 714. This leaves the dataflow execution graph with operators 201′, 202′, 203′ and 204′, and edges 211′ through 214′, 615 and 616 (which is identical to the new dataflow execution graph 600).

After operators 203′, 605 and 204′ each process the control message, the respective operator thereafter begins processing incoming data messages, and also reports the completion of control processing to the controller. At this point, the intermediate dataflow execution graph 700B has taken the form of the new dataflow execution graph 600, and the data stream(s) is/are executing on the new dataflow execution graph 600.

Another optimization can be formed if the dataflow execution graph is acyclic. In that case, common operators 203 and 203′ can be collapsed into operator 203′ (eliminating edges 211, 213, and 713), and common operators 204 and 204′ can be collapsed into operator 204′ (eliminating edges 212, 214, and 714) without breaking the acyclic invariance. Furthermore, such acyclic invariance can be maintained for scaling-out and scaling-in by using hashing algorithms as a partitioning scheme. This collapse leaves remaining only five operators 201′ through 204′ and 605 in the intermediate dataflow execution graph 705. There are also eight edges 211′ through 214′, 701, 702, and 615 and 616 in the intermediate dataflow execution graph 700C.

In FIG. 7C, the control message is provided first to the operators 201′ and 202′. After operator 201′ processes the control message, the control message is passed along directed edges 211′, 615, and 212′ to respective operators 203′, 605 and 204′. The operator 201′ will then begin processing data messages since it is an operator within the new dataflow execution graph 600. After operator 202′ processes the control message, the control message is passed along directed edges 213, 616 and 214′ to respective operators 203′, 605 and 204′. The operator 202′ will then begin processing data messages since it is an operator within the new dataflow execution graph 600.

As part of processing the control message, operator 203′ will perform some transformation on its own state as dictated by the control message, and provide that transformed state along directed edge 701 to the operator 605. After operator 203′ processes the control message, the control message is passed along directed edge 701 to operator 605, and will then begin processing data messages. Directed edge 701 may then be removed. As part of processing the control message, operator 204′ will perform some transform on its own state as dictated by the control message, and provide that transformed state along directed edge 702 to the operator 605. After operator 204′ processes the control message, the control message is passed along directed edge 702 to operator 605, and will then begin processing data messages. Directed edge 702 may then be removed. After operator 605 processes the control message, the operator will thereafter begin processing incoming data messages, and also report the completion to the controller. At this point, the intermediate dataflow execution graph 700C (although already having the form of the new dataflow execution graph 600) is executing the data stream.

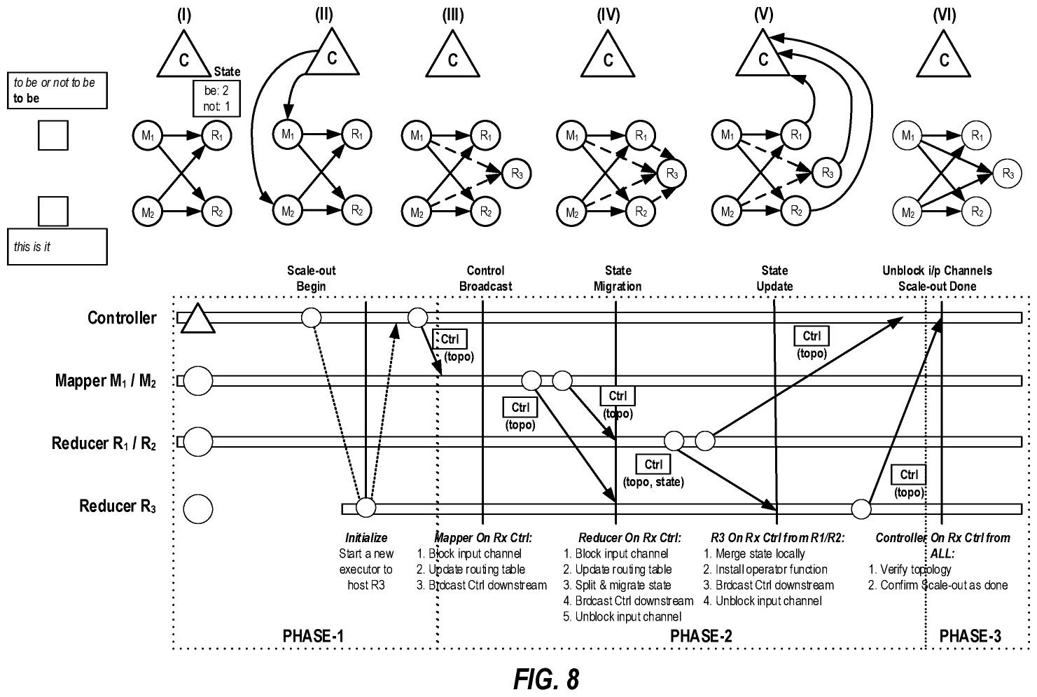

FIG. 8 is a diagram showing a timeline view 800 of the described configuration. In the illustrated case, the old dataflow execution graph counts the number of words in events it receives. The stateless operators 201 and 202 are mapping operators (shown as M1 and M2, respectively), each capable of receiving a data stream. The upper mapping operator M1 is shown as receiving the text string “to be or not to be”. The lower mapping operator M2 is shown as receiving the text string “this is it”. The stateful operators 203 and 204 are shown as reduce operators (shown as R1 and R2, respectively), that count respective occurrences of words. Reduce operator R1 initially counts occurrences of words that begin with A through L. Reduce operator R2 initially counts occurrences of words that begin with M through Z. The state of operator R1 shows that so far, the reduce operator has counted 2 instances of “be” and 1 instance of “not”. The controller 110 is shown as an upward-facing triangle marked with “C”. The lower portion of FIG. 8 shows a timewise diagram of communications between the controller, the mappers M1 and M2, the reducers R1 and R2, and a new reducer R3. We began with stage I.

Moving to the right to stage II, the controller starts a new executor to host a new reducer R3. When the controller is notified that the new reducer R3 is ready, the controller starts the scale-out by broadcasting a control message with the new topology information to all the source operators M1 and M2. When the source operator (e.g., M1 or M2) receives the scale-out control message, as shown in stage III, the mapper immediately blocks the input channel while processing the control message, updates its routing table with the new topology, and broadcasts the message downstream along the dataflow execution graph.

As shown in stage IV, when the reducer R1 or R2 receives the control message, the reducer also blocks its incoming channel on which the message has been received. When the control message from all input channels has been received, the reducer R1 or R2 updates its routing table and checkpoints its state. Next, the reducer splits the state into two parts (e.g., accumulated counts for words starting with “A” through “G”, and accumulated counts for words starting with “H” through “L”). The reducers then attach the state that needs to be handled by the reducers R3 (“H” to “L”) to the control message and broadcasts along all output channels to that reducer R3. The reducers R1 and R2 then signal completion to the controller.

As shown in stage V, when the reducer R3 receives the control message, it blocks that input channel. If the control message originates from R1 (or R2), the reducer R3 records the state from the control message. When the reducer R3 receives control messages from all input channels, the reducer proceeds to install a new function (from the control message) using the state merged from all the recorded states.

As shown in stage VI, finally, the reducer R3 broadcasts on the output channel to the controller that it also has completed processing the control message. When the controller receives completion acknowledgement messages from all the expected sink operators, the scale-out operation is complete.

Because the principles described herein operate in the context of a computing system, a computing system will be described with respect to FIG. 9. Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 9, in its most basic configuration, a computing system 900 typically includes at least one hardware processing unit 902 and memory 904. The memory 904 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 900 has thereon multiple structures often referred to as an “executable component”. For instance, the memory 904 of the computing system 900 is illustrated as including executable component 906. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the term “component” or “vertex” may also be used. As used in this description and in the case, this term (regardless of whether the term is modified with one or more modifiers) is also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 904 of the computing system 900. Computing system 900 may also contain communication channels 908 that allow the computing system 900 to communicate with other computing systems over, for example, network 910.

While not all computing systems require a user interface, in some embodiments, the computing system 900 includes a user interface 912 for use in interfacing with a user. The user interface 912 may include output mechanisms 912A as well as input mechanisms 912B. The principles described herein are not limited to the precise output mechanisms 912A or input mechanisms 912B as such will depend on the nature of the device. However, output mechanisms 912A might include, for instance, speakers, displays, tactile output, holograms, virtual reality, and so forth. Examples of input mechanisms 912B might include, for instance, microphones, touchscreens, holograms, virtual reality, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or components and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface component (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program components may be located in both local and remote memory storage devices.

Those skilled in the art will also appreciate that the invention may be practiced in a cloud computing environment, which is supported by one or more datacenters or portions thereof. Cloud computing environments may be distributed, although this is not required. When distributed, cloud computing environments may be distributed internationally within an organization and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand, self-service, broad network access, resource pooling, rapid elasticity, measured service, and so forth. A cloud computing model may also come in the form of various application service models such as, for example, Software as a service (“SaaS”), Platform as a service (“PaaS”), and Infrastructure as a service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Accordingly, the principles described herein provide a mechanism for modifying or reconfiguring a dataflow execution graph with little, if any, latency. The dataflow execution graph may continue to receive and process the data stream(s) for most of the time that the dataflow execution graph is reconfiguring. Thus, the dataflow execution graphs may be frequently reconfigured to dynamically respond to temporal and spatial variability, and to respond to other performance uncertainly. Thus, resources need not be over-provisioned to support worst-case scenarios. Thus, the principles described herein promote more efficient use of resources.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to perform a method for modifying a dataflow execution graph that processes one or more data streams, the method comprising:
generating one or more control messages that are not part of the one or more data streams;
flowing the one or more data streams and the one or more control messages through an intermediate dataflow execution graph that has operators that include at least the common operators of both an old and a new dataflow execution graph, and that has edges that include at least the common edges of both the old and new dataflow execution graphs; and
converting the intermediate dataflow execution graph into the new dataflow execution graph while continuing to process the one or more data streams, by performing the following:
for each operator of the intermediate dataflow execution graph that is not part of the new dataflow execution graph, shutting down the operator after that operator executes at least one of the one or more control messages, such that the operator ceases to be able to continue processing data messages, and
for each operator of the intermediate dataflow execution graph that is not part of the old dataflow execution graph, having that operator begin processing of data messages after the operator processes at least one of the one or more control messages.

2. A method for modifying a dataflow execution graph that processes one or more data streams, the method comprising:
generating one or more control messages that are not part of the one or more data streams;
flowing the one or more data streams and the one or more control messages through an intermediate dataflow execution graph that has operators that include at least the common operators of both an old and a new dataflow execution graph, and that has edges that include at least the common edges of both the old and new dataflow execution graphs; and
converting the intermediate dataflow execution graph into the new dataflow execution graph while continuing to process the one or more data streams, by performing the following:
for each operator of the intermediate dataflow execution graph that is not part of the new dataflow execution graph, shutting down the operator after that operator executes at least one of the one or more control messages, such that the operator ceases to be able to continue processing data messages, and
for each operator of the intermediate dataflow execution graph that is not part of the old dataflow execution graph, having that operator begin processing of data messages after the operator processes at least one of the one or more control messages.

3. The method in accordance with claim 2, the intermediate dataflow execution graph also including edges that capture state dependency relationships between common stateful operator(s) of the old dataflow execution graph and common stateful operator(s) of the new dataflow execution graph.

4. The method in accordance with claim 3, the method further comprising: transferring state along all edges that capture state dependency relationships.

5. The method in accordance with claim 3, the intermediate dataflow execution graph also including stateful operators of both the old and new dataflow execution graphs, and also including edges that capture dependency relationships between stateful operators of the new dataflow execution graph, and stateful and common stateless operators of the old dataflow execution graphs.

6. The method in accordance with claim 5, the method further comprising: transferring state along all edges that capture state dependency relationships.

7. The method in accordance with claim 5, the intermediate dataflow execution graph also including stateless operators of both the old and new dataflow execution graphs.

8. The method in accordance with claim 7, the intermediate dataflow execution graph also including edges between each stateless operator of the old dataflow execution graph and a same instance of a respective stateless operator of the new dataflow execution graph.

9. The method in accordance with claim 2, wherein for each operator of the intermediate dataflow execution graph that is not part of the new dataflow execution graph, the method includes shutting down the operator after that operator executes all of the one or more control messages, such that the operator ceases to be able to continue processing data of the data streams.

10. The method in accordance with claim 9, wherein for each operator of the intermediate dataflow execution graph that is not part of the old dataflow execution graph, the method includes having that operator begin processing of data messages after the operator processes at least one of the one or more control messages.

11. The method in accordance with claim 2, wherein for each operator of the intermediate dataflow execution graph that is not part of the old dataflow execution graph, the method includes having that operator begin processing of data messages after the operator processes at least one of the one or more control messages.

12. The method in accordance with claim 2, the old and new dataflow execution graphs including a common stateful operator, the common stateful operator of the new dataflow execution graph including a changed state compared to the common stateful operator of the old dataflow execution graph.

13. The method in accordance with claim 2, the old and new dataflow execution graphs including a common stateful operator, the common stateful operator of the new dataflow execution graph including a changed parameter compared to the common stateful operator of the old dataflow execution graph.

14. The method in accordance with claim 2, the old and new dataflow execution graphs including a common stateful operator, the common stateful operator of the new dataflow execution graph including a changed function compared to the common stateful operator of the old dataflow execution graph.

15. The method in accordance with claim 2, the old and new dataflow execution graphs including a common edge, the common edge of the new dataflow execution graph including a changed parameter compared to the common edge of the old dataflow execution graph.

16. The method in accordance with claim 2, the one or more data streams each being an event stream.

17. The method in accordance with claim 2, further comprising:
receiving a configuration instruction, the generating of the one or more control messages being performed in response to receiving the configuration instruction.

18. The method in accordance with claim 17, further comprising:
confirming that all sink operators in the new dataflow execution graph have executed one or more control messages; and
reporting that the configuration instruction has been executed.

19. The method in accordance with claim 2, further comprising:
confirming that all sink operators in the new dataflow execution graph have executed one or more control messages.

20. A computer program product comprising one or more computer-readable storage media having thereon computer-executable instructions that are structured such that, when executed by the one or more processors, cause the computing system to perform a method for modifying a dataflow execution graph that processes one or more data streams, the method comprising:
generating one or more control messages that are not part of the one or more data streams;
flowing the one or more data streams and the one or more control messages through an intermediate dataflow execution graph that has operators that include at least the common operators of both an old and a new dataflow execution graph, and that has edges that include at least the common edges of both the old and new dataflow execution graphs; and
converting the intermediate dataflow execution graph into the new dataflow execution graph while continuing to process the one or more data streams, by performing the following:
for each operator of the intermediate dataflow execution graph that is not part of the new dataflow execution graph, shutting down the operator after that operator executes at least one of the one or more control messages, such that the operator ceases to be able to continue processing data messages, and
for each operator of the intermediate dataflow execution graph that is not part of the old dataflow execution graph, having that operator begin processing of data messages after the operator processes at least one of the one or more control messages.
